(19) United States
(12) Patent Application Publication
(10) Pub. No.: US 2016/0146410 A1
(43) Pub. Date: May 26, 2016

(54) Tree Lighting System

(71) Applicant: Eugene Moscone, Sunrise, FL (US)

(72) Inventor: Eugene Moscone, Sunrise, FL (US)

(21) Appl. No.: 15/014,358

(22) Filed: Feb. 3, 2016

Related U.S. Application Data
(60) Provisional application No. 62/147,038, filed on Apr. 14, 2015.

(51) Int. Cl. F21S 4/15; F21V 17/00

(52) U.S. Cl. CPC F21S 4/15; F21V 17/007; F21Y 2101/02; F21W 2121/04

(57) ABSTRACT

A tree lighting system for quickly installing lights on a tree. The system includes a tree lighting assembly wherein the tree lighting assembly includes a tiered, cone-shaped net extending between a first ring and a second ring. The net supports a plurality of lights thereon, whereby the diameter of the second ring is larger than that of the first ring. This allows the tree lighting assembly to have a hollow interior volume when the net is expanded into its conical shape. The tree lighting assembly is placed over a tree, whereby the body of the tree is disposed within the interior volume of the tree lighting assembly.

### CROSS REFERENCE TO RELATED APPLICATIONS

This application claims the benefit of U.S. Provisional Application No. 62/147,038 filed on Apr. 14, 2015. The above identified patent application is herein incorporated by reference in its entirety to provide continuity of disclosure.

### FIELD OF THE INVENTION

The present invention relates to tree lighting systems. More specifically, the present invention relates to a collapsible cone-shaped net that supports lights between two rings.

### BACKGROUND OF THE INVENTION

People can spend hours decorating their home for Christmas, including stringing lights onto a Christmas tree. This task involves tediously wrapping single strands of lights around the tree and constantly repositioning the lights for maximum coverage. Further, wrapping single strands of lights around a Christmas tree can be exceptionally difficult when the tree is placed in the corner of the room or adjacent to a wall. This is also true where the tree is exceptionally large, such as those used in a public space or at a mall. There have been many attempts to solve this problem including netting with lights and pre-lit artificial trees.

Netting embedded with lights are known in the art. For some nets, the user must first mount the lighting assembly to the apex of the tree and manually wrap the lighting assembly around the tree. Other nets require the user to wrap pieces of netting around the surface of the tree from the base to the apex. Therefore, there exists a need in the prior art for a lighting assembly that the user can place onto the entire surface of a Christmas tree without having to walk around the tree and continuously adjust the placement of the netting.

Collapsible Christmas trees and light stands are known in the prior art. However, in some systems, the lights are spirally wrapped around the rigid tubular members that comprise the stand. In other systems, the artificial Christmas tree utilizes upper and lower rings to secure a netting with lights dispersed thereon. However, these systems have a collapsible pole through the center which connects the upper and lower rings. These rings have arcuate rods disposed on the diameter to provide support for the tree and the decorative tree topper. Although the artificial trees and light stands are collapsible, the lighting assemblies are built into them and are not removable or customizable. Thus, these lighting assemblies may not be used to decorate real trees.

Therefore, there exists a need for a tree lighting system comprising a collapsible, cone-shaped netting with lights which is sized to receive a tree therein.

### SUMMARY OF THE INVENTION

In view of the foregoing disadvantages inherent in the known types of tree lighting assemblies now present in the prior art, the present invention provides a collapsible netting with lights wherein the user can conveniently light a tree by sliding a tree lighting assembly over the body of the tree. The present tree lighting assembly comprises a tiered, cone-shaped net that extends between a pair of rings. The tree lighting assembly comprises a first ring and a second ring, wherein the second ring has a larger diameter, thus providing the structure for the cone-shaped netting.

A plurality of lights are disposed along the length of the netting. This allows the user to light a tree in one easy step by placing both the first and second rings above the top of the tree and pulling the second ring downward. By pulling the second ring downward, the netting is pulled over the body of the tree, thereby lighting the tree. The present system is also collapsible for easy storage. The user can lift the second ring upward until it meets the first ring, whereby the user can easily carry the tree lighting assembly and hang it in storage.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of the tree lighting assembly without lights in the extended position.

FIG. 1B shows a perspective view of the tree lighting assembly with lights in the extended position.

FIG. 2 shows a perspective view of the tree lighting assembly with lights in the collapsed position.

FIG. 3 shows a perspective view of one embodiment of an adjustment mechanism.

### DETAILED DESCRIPTION OF THE INVENTION

Reference is made herein to the attached drawings. Like reference numerals are used throughout the drawings to depict like or similar elements of the tree lighting assembly. For the purposes of presenting a brief and clear description of the present invention, the preferred embodiment will be discussed as used for easily decorating a tree. The figures are intended for representative purposes only and should not be considered to be limiting in any respect.

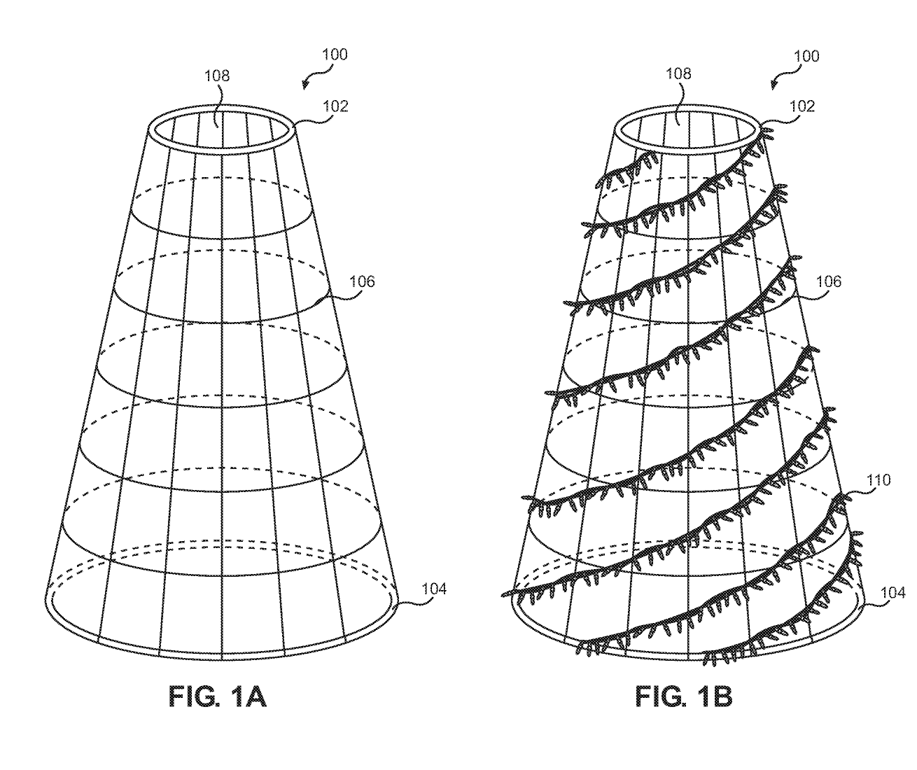

Referring now to FIG. 1A, there is shown a perspective view of the tree lighting assembly without lights in the extended position. The tree lighting assembly 100 comprises a first ring 102, a second ring 104, and a netting 106 that extends between the first ring 102 and the second ring 104, defining a hollow interior volume 108. The rings may be composed of rigid or flexible material. In the depicted embodiment, the rings are circular and rigid, with the second ring 104 having a larger diameter than the first ring 102. This difference in diameter allows the netting 106 to form a conical shape, whereby the body of the tree is disposed within the interior volume 108 of the tree lighting assembly 100.

To accomplish this, the tree lighting assembly 100 is held in a collapsed position at the apex of the tree. Due to its smaller diameter and rigid material, the first ring 102 remains at the top of the tree while the user pulls downward on the second ring 104. Downward motion of the first ring 102 is restricted because it cannot move past branches that become increasingly longer down the length of the tree. The user continues to pull the second ring 104 downward over the body of the tree until the tree lighting assembly 100 is in an extended position.

The conical shape of the netting 106 accommodates the conical shape of the tree. The netting 106 can be made of thin wire mesh or more flexible material such as plastic fibers of a fabric material. Further, the netting 106 may have large spaces between the wires or fibers to accommodate tree branches. This is more aesthetically pleasing because there is less netting 106 that will be visible to the user when the tree branches can protrude through the netting.

Referring now to FIG. 1B, there is shown a perspective view of the tree lighting assembly with lights in the extended position. In the depicted embodiment, a plurality of lights 110 are securely disposed along the netting 106 in a diagonal configuration. However, the lights may be disposed in numerous other configurations such as vertical, horizontal, lattice, or the like. The lights 110 are preferably spaced at a fixed interval so that the lights are evenly distributed on the netting. Further, the lights 110 are preferably LEDs so as to provide high brightness with low power consumption. As the ring assembly 100 moves from a collapsed position over the apex of the tree to an extended position, the netting 106 with the attached lights 110 covers the body of the tree.

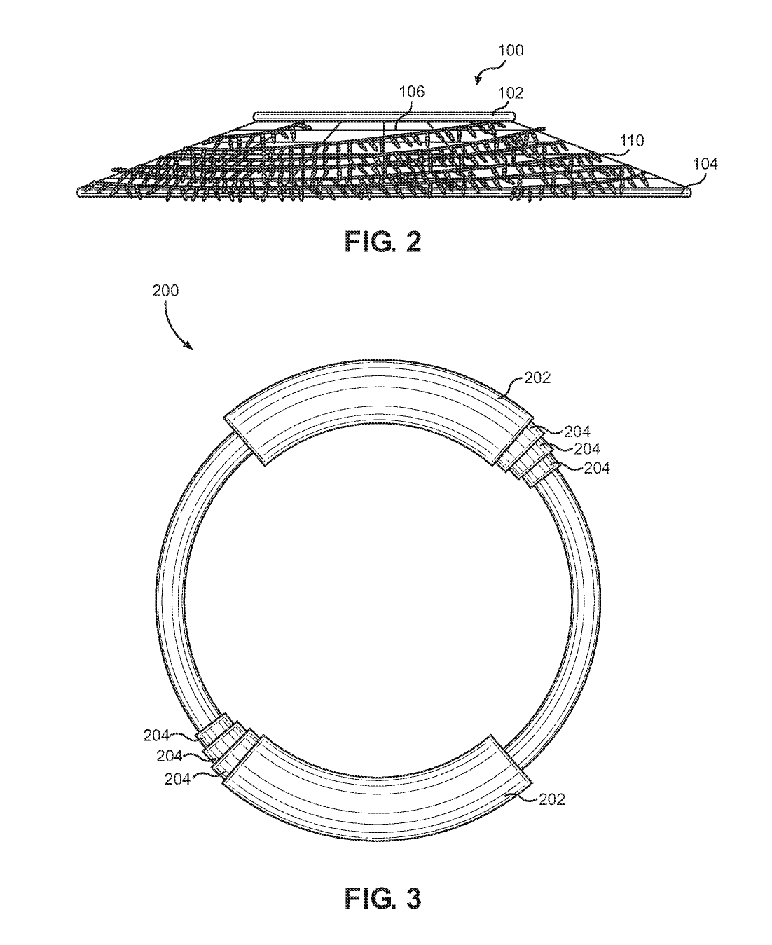

Referring now to FIG. 2, there is shown a perspective view of the tree lighting assembly with lights in the collapsed position. When the tree lighting assembly 100 is not in use over a tree, it can be collapsed for easy transportation and storage. The tree lighting assembly 100 is removed from the tree by pulling the second ring 104 upward until it meets the first ring 102. Because the lights 110 are securely disposed along the netting 106, they do not tangle as the second ring 104 moves upward. The netting 106 and lights 110 fold as the second ring 104 is moved closer to the first ring 102. Once both rings are joined at the apex of the tree, the user can remove the tree lighting assembly 100 from the tree. The shape of the rings provide the user a means for carrying the tree lighting assembly 100 and hanging it for storage.

Referring now to FIG. 3, there is shown a perspective view of one embodiment of an adjustment mechanism. In various embodiments of the tree lighting assembly, the first ring 102 and the second ring 104 incorporate an adjustment mechanism 200. This will allow the user to customize the tree lighting assembly to accommodate trees of different sizes. One embodiment of an adjustment mechanism is a tubular ring 202 with one or more telescopic sections 204. The telescopic sections may be expanded to increase the diameter of the ring or compressed to decrease the diameter of the ring.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A tree lighting system, comprising:
a tree lighting assembly having a first ring, a second ring, and a netting extending between said first ring and said second ring, defining a hollow interior volume in which a tree can be positioned;
a plurality of lights affixed to said netting;
wherein said tree lighting assembly is movable between a collapsed configuration and an extended configuration such that said netting extends over said tree.

2) The tree lighting system of claim 1, wherein the first ring and the second ring comprise an adjustment mechanism adapted to adjust the diameter of the first ring and the second ring, respectively.

3) The tree lighting system of claim 1, wherein the first ring and the second ring are composed of a rigid material.

4) The tree lighting system of claim 1, wherein the first ring and the second ring are circular in configuration.

5) The tree lighting system of claim 1, wherein the netting comprises a flexible fabric material.

6) The tree lighting system of claim 1, wherein the plurality of lights are spaced at a fixed interval.

7) The tree lighting system of claim 1, wherein the plurality of lights comprise LEDs.

8) The tree lighting system of claim 1, wherein the plurality of lights are distributed across the netting.
